(19) United States
(12) Patent Application Publication
(10) Pub. No.: US 2018/0267975 A1
(43) Pub. Date: Sep. 20, 2018

(54) Method, Computer Program and System for Transmitting Data in Order to Produce an Interactive Image

(71) Applicant: Siemens Aktiengesellschaft, Muenchen (DE)

(72) Inventors: Clemens SCHMITT, Erlangen (DE); Michael UNKELBACH, Buckenhof (DE); Johannes WEISS, Lisberg (DE)

(21) Appl. No.: 15/762,861

(22) PCT Filed: Sep. 23, 2016
(86) PCT No.: PCT/EP2016/072746

§ 371 Date: Mar. 23, 2018

(30) Foreign Application Priority Data
Sep. 24, 2015 (DE) 10 2015 218 348.3

(51) Int. Cl. G06F 17/30; G06F 3/0481; H04L 29/06

(52) U.S. Cl. CPC G06F 17/3056; G06F 17/30554; H04L 67/42; G06F 3/04812

(57) ABSTRACT

A method for transmitting data to produce an interactive image, a computer program for implementing the method and a client-server system operating based on the method, wherein the server, when handling a large volume of data, produces an image based on the data and transmits the image to the client for display by the client, where in the event of a user action relative to the image, user action-specific coordinates are transmitted from the client to the server that determines in the data a data point associated with the user action-specific coordinates and the pertaining detailed information and transmits the detailed information to the client for display on the client such that large volumes of data can be displayed on the client via a small data transfer between the server and the client.

### CROSS-REFERENCE TO RELATED APPLICATIONS

This is a U.S. national stage of application No. PCT/EP2016/072746/ filed Sep. 23, 2016. Priority is claimed on German Application No. DE 10 2015 218 348.3 filed Sep. 24, 2015, the content of which is incorporated herein by reference in its entirety.

### BACKGROUND OF THE INVENTION

### 1. Field of the Invention

The invention relates to a method for transmitting data to produce an interactive image via a system in which a first device functions as a server and a second device communicatively connected to the first device functions as a client, relates to a system operating in accordance with the method and to a computer program for implementing the method.

### 2. Description of the Related Art

The quality of a representation of data, for example, on a computer screen of a client of a client-server system is determined, inter alia, by a respective data quantity and the transfer speed enabled by the communicative connection between the client and the server, for example, a conductor-bound or conductor-free connection. With a data quantity of, for example, 200 MB on the server side, at a transfer speed of 100 Mbit/s (fast Ethernet), a transfer time of 17 seconds results. This is significantly too long for a visualization of the data occurring at least approximately in real time.

A trivial solution for transmitting data to produce an interactive image based on a large static data quantity via a device (client) remote from the storage location of the data quantity (server) lies in reducing the data quantity and transferring only the reduced data quantity to the client for display at this location. The reduction of the data quantity, however, necessarily leads thereto that on the client side, data is lacking and that therefore no interactive access by a user thereto is possible.

A good interactivity, i.e., access to the complete data quantity is therefore seemingly not combinable with a rapid image representation.

### SUMMARY OF THE INVENTION

In view of the foregoing, it is therefore an object of the present invention to provide a solution by which, given a necessarily limited transfer speed of the communicative connection between the server and the client, a large server-side data quantity can be represented sufficiently rapidly on the client side, where simultaneously, access to the entire server-side data quantity is possible.

This and other objects and advantages are achieved in accordance with the invention by a system, a device and a method for transmitting data to produce an interactive image from large data quantities via a system in which a first device functions as a server and in which at least one second device communicatively connected to the first device functions as a client. In accordance with the invention, the server produces an image and transmits it to the client based on data present on the server side in the form of a plurality of data points. The generation of the image brings about a reduction in the data quantity. The image can also be generated in a compressed format or at least transferred in the compressed format. Compressed image formats and methods for generating compressed images are per se known. The client represents the image received from the server via a display unit. The user of the client receives the impression when observing the image that the complete data quantity is displayed by the image. If the user undertakes a user action in relation to the image, for example, the selection of an image point via a pointing device, such as a mouse, the client transmits user action-specific coordinates to the server based on the user action relating to the image. On receiving the coordinates in the data on which the originally transmitted image is based, the server establishes the associated data point and a detail information item for this data point. The server transmits this detail information item to the client, which represents the detail information item at the location of the user action or with a reference to the location of the user action. In this way, an interactive image is produced.

The advantage of the solution proposed here lies therein that a representation of mass data (“big data”) in the form of an interactive image on the client is enabled despite the bottleneck of the low transfer rate between the client and the server. Also advantageous is the transmitting of the data to the client divided into two parts without this being obvious to the user. In a first step, based on the data to be visualized, via the server and utilizing its computational capacity, an image is produced and this is transmitted to the client for representation. Based on the data quantity of the resulting image that is significantly smaller as compared with the data quantity of the underlying data, the transmission of the image to the client and the representation of the image there occurs very rapidly. As soon as the image is represented at the client, a possibility arises for the user of visual interpretation of the data and the undertaking of operating actions in relation to the image, which can also be designated “interactivity”. An operating action is, for example, a selection of an image point. Following the selection of such an image point, in a second step, a detail information item is established regarding the selected image point, transmitted to the client and represented there by the client. The quantity of the data initially to be transferred for this from the client to the server and subsequently from the server to the client is very small and is in the region of a few bytes. On the user action, user action-specific coordinates, for example, the coordinates of the selected image point, are transmitted from the client to the server. Subsequently, the detail information belonging to the user action-specific coordinates is transmitted to the client by the server. For the user on the client side, the impression arises that every detail information item callable with the user action was already originally present at the client, therefore as if the complete set of the visualized data had been directly available on the server side with the representation of the interactive image. It should be noted: The expression “data” used in the preamble includes all data, images and information which is transmitted (in whichever direction) between the server and the client. The expression therefore includes, at least: Images 30, user action-specific coordinates 36 and detail information items 40.

References used herein with respect to disclosed embodiments herein relate to the further development of the subject matter of the main claim with the features of the respective subclaim. They should not be understood as dispensing with the achievement of a self-sufficient subject matter protection for the feature combinations of the backward-referring subclaims.

Furthermore, with regard to an interpretation of the claims on a closer specifying of a feature in a subordinate claim, it can be assumed that such a restriction does not exist in the respective preceding claims. Finally, it should be noted that the method set forth here can also be further developed in accordance with the dependent device claims. The same applies for the device, i.e., in particular the client-server system that can be further developed in accordance with the dependent method claims, for example, in that the device comprises means for carrying out the aspects defined in the dependent method claims.

In one embodiment of the method, the client represents the image received from the server and the detail information received from the server in different levels resulting due to individually addressable storage regions. The allocation of image data to different levels and an overlaying of the levels for obtaining the respective image representation are per se known. For differentiation, the different levels are designated the drawing level and the information level. The image received from the server is represented in the drawing level. The detail information item also received from the server is represented in the information level. For the production of a respective display via the display unit, the contents the two levels, i.e., the content of the associated storage regions are linked to one another. In a logical OR-linking of the contents of the information level with the contents of the drawing level, an overlaying of the two levels results and as the result of the overlaying, a combination of the image and the detail information appears as a resultant representation.

In accordance with the present embodiment of the method, the image originally received at the client from the server is loaded into the storage region corresponding to the drawing level. The storage region corresponding to the information level is deleted to receive a transparent level (filled with “0”s) and only at the location of the detail information item to be represented does a bit pattern differing therefrom appear in the storage region.

Such a representation of the original image and the detail information in two mutually independent but overlaid levels has the advantage that the representation of the detail information can be “deleted” rapidly and unproblematically in that either the storage region functioning as the information level is deleted or the linkage of the two levels for receipt of the display is temporarily lifted and in its place only the drawing level is used for the receipt of the display. The representation of the image originally received from the server remains unchanged and at a later time point can be linked to another detail information item in the above-described manner.

In another embodiment of the method, the server applies a transformation rule and an inverse of the transformation rule. The server applies the transformation rule upon generation of the image for converting the data points into image points of the image. The server applies the inverse of the transformation rule on the user action-specific coordinates received from the client upon a user action there. By applying the inverse, the server establishes the data point belonging to the user action-specific coordinates and subsequently its detail information.

An example will serve to illustrate this further. In a representation of the data to be visualized in a polar diagram, for example, data that is recorded at a turbine with regard to a respective momentary rotation angle co of the turbine, the server generates the image to be transmitted to the client in that the totality of the data points included by the recorded data relating to the rotation angle co and, for example, the amplitude, are entered in the polar diagram. The image to be generated is configured in a per se known manner from image points arranged in rows and columns and thus is based on Cartesian coordinates. For conversion of the polar coordinates of the data points into Cartesian coordinates of the image points, a transformation in the form of the per se known transformation rule for conversion from polar coordinates into Cartesian coordinates is used (x=r cos ω; y=r sin ω). The user action-specific coordinates fed back from the client in the event of a user action are, for example, Cartesian coordinates, in particular coordinates that relate to the size of the display unit or the extent of a window represented on the display unit (respectively in image points). Such user action-specific coordinates can be converted with a per se known transformation rule into polar coordinates. This transformation rule can be regarded as the inverse of the aforementioned transformation rule because, via the transformation rule, a conversion from polar coordinates into Cartesian coordinates and via the inverse, a conversion from Cartesian coordinates into polar coordinates occurs. As soon as, following use of the inverse, possibly after prior use of a linear displacement for centering the coordinate origin, the associated polar coordinates of the image point are established by the server, the server can select the appropriate data point in the data and transmit its detail information to the client. This applies accordingly for other possible transformations and associated inverses.

It is also an object of the present invention to provide a system that comprises a server and at least one client, where the server, i.e., a device functioning as a server and the or each client, specifically a device functioning as a client, each have means for implementing the method as described here and in the following. As means of this type, for example, a computer program with an implementation of the method and, if relevant, individual or all of the embodiments of the method come into consideration. In this regard, the invention is preferably implemented in software. The invention is thus firstly also a computer program with program code instructions executable by a computer and, secondly, a storage medium with such a computer program, i.e., a computer program product with program code means and, finally, also a system with a server and at least one client, where such a computer program is loaded or loadable into a memory store of the respective devices as means for performing the method and its embodiments.

It is clear to a person skilled in the art that in place of an implementation of a method in software, an implementation in firmware or in firmware and software or in firmware and hardware is always possible. Therefore, for the description set forth here, it should be the case that the term software or the term computer program, other implementation possibilities, specifically in particular an implementation in firmware or in firmware and software or in firmware and hardware are included.

An exemplary embodiment of the invention will now be described in greater detail making reference to the drawings. Objects or elements which correspond to one another are provided with the same reference signs in all the drawings, in which:

### BRIEF DESCRIPTION OF THE DRAWINGS

FIG. 1 shows a client-server system with an image produced by the server based on data present at the server and the representation of the image at the client via a display unit of the client in accordance with the invention;

FIG. 2 shows a transmission of data from and to the client for representing a detail information item relating to an image point of an image produced by the server at the client in accordance with the invention;

FIG. 3 shows a drawing level and an information level for simultaneous representation of an image produced by the server and a detail information item relating to an image point of the image at the client in accordance with the invention; and

FIG. 4 shows an interaction layer at the client for acquiring user actions in accordance with the invention; and

FIG. 5 is a flowchart of the method in accordance with the invention.

### DETAILED DESCRIPTION OF THE EXEMPLARY EMBODIMENTS

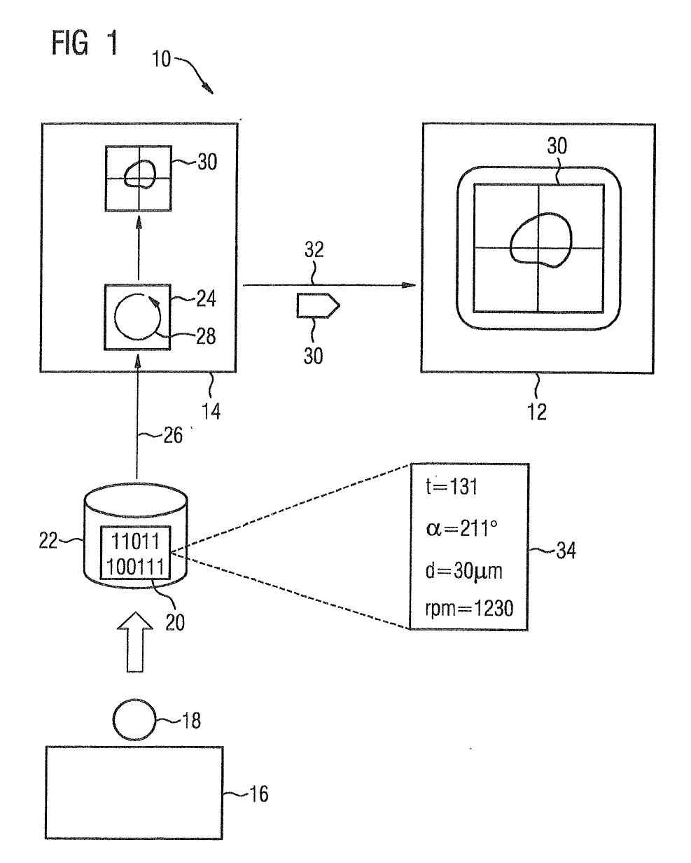

FIG. 1 shows, in a schematic simplified manner, a client-server system 10 with at least one device functioning as a client 12 and one device functioning as a server 14. The or each client 12 is communicatively connected to the server 14 in a fundamentally per se known manner. For communicative connection, a conductor-bound or conductor-free connection (not shown) comes into consideration. An example of a conductor-bound connection is an Ethernet connection. The following description is continued using the example of a client-server system 10 with exactly one client 12. However, the approach proposed here applies equally for a plurality of clients 12 and, accordingly, a plurality of clients 12 should always be understood as being covered.

The client 12 is, for example, a device in the form of a PC, a laptop or a mobile terminal, such as a Smartphone or a tablet PC. In the client-server system 10, such a client 12 is a “thin client” in the sense that the client 12 functions substantially as a terminal connected to the server 14 and output from the server 14 occurs via of a display unit of the client 12 and user input occurs via the peripherals provided therefor (e.g., a keyboard, or mouse) of the client 12. Data to be displayed is herein transmitted from the server 14 to the client 12 and data relating to user input is transmitted from the client 12 to the server 14. Memory-intensive and/or computation-intensive processing occurs at the server 14.

The approach proposed here is based on the following scenario: In or on a technical system 16, such as a turbine, via a fundamentally per se known sensor technology 18, data 20 is recorded and stored in a database 22. The data quantity is significant, such as 200 MB and more. With a turbine, for example, due to its rotary speeds in operation and a finely-spaced sampling for the acquisition of, for example, measurement values regarding the vibration behavior, a large data quantity 20 results. The data 20 is present at the server 14, for example because the acquisition thereof occurs via the server 14 or under the control of the server 14. A representation of the data 20 is to occur at the client 12 via the display unit comprised by the client 12, for example, in the form of a polar diagram.

The server 14 comprises, in a per se known manner, a processing unit in the form of or in the manner of a microprocessor and a memory store. At least one computer program 24 that determines the functionality of the server 14 is loaded into the memory store. During operation of the client-server system 10, the server 14 accesses the data 20 stored in the memory store of the server 14 or a mass memory store comprised by the server 14 or assigned to the server 14 and data 20 stored there (access 26) and processes it via the processing unit and in accordance with the computer program 24 (processing 28). The result of the processing is at least an image 30 generated based on the data 20 by the server 14, i.e., for example, an image 30 that shows a polar diagram. Belonging to each image point of the image 30 is a data point 34 of the data 20 processed during the generation of the image. In order to produce a respective image point for a data point 34, the server 14 performs a transformation of the type described in the general description part. In the representation of FIG. 1, by way of example, possible data of a data point 34 is represented. The data 20 comprises a plurality of such data points 34 with respectively different data according to the measurement value recording via the sensor system 18.

The production of the image 30 implies a reduction in the underlying data quantity 20. The image 30 can also be stored in a compressed format. The image 30 is transferred from the server 14 to the client 12 (transfer 32) and the client 12 represents the image 30 on its display unit, i.e., typically a screen. For the representation of the image 30 at the client 12, for example, a pre-installed web browser is used, such that no installation of a special client application is necessary. Nevertheless, at the client 12, using a processing unit there in the form or of the type of a microprocessor, at least one computer program (not shown separately in the drawings) is provided that determines the functionality of the client 12. A web browser or the like is an example of a computer program of this type.

When the image 30 is displayed at the client 12, it is available there not only for a visual interpretation by a user, but also for a further-reaching interaction. Such an interaction designated below as a user action consists, for example, therein that the user selects, via a peripheral device of the client 12, i.e., for example, a mouse or another pointing device, an image point of the display unit and thus an image point of the image 30 for the receipt of a further information item. The image 30 itself does not contain this further information. However, the further information is a component of the data 20 underlying the image 30. In order to receive the further information, in the case of a user action at the client 12, user action-specific coordinates 36 are established and transmitted to the server 14.

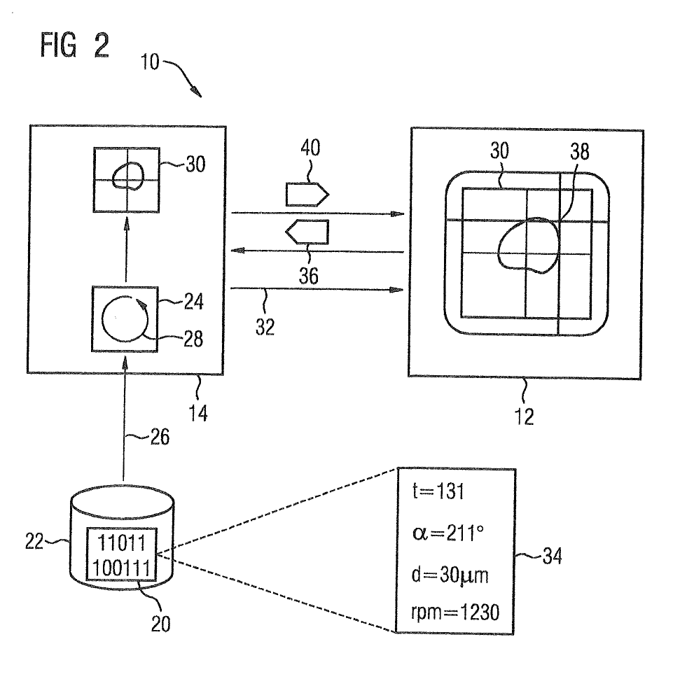

For this purpose, in the representation in FIG. 2, which essentially corresponds to FIG. 1, a graphic cursor 38 at the client 12 is shown. This is movable in a per se known manner in relation to the image 30 displayed by the client 12, so that an individual image point can be selected. Such a selection is an example for a user action and the user action-specific coordinates 36 correspond to the respective position of the graphic cursor 38. These are transmitted to the server 14 and the server 14 establishes the respectively associated data point 34 for them. The information encompassed thereby is transmitted as detail information 40 to the client 12 and displayed together with the image 30.

For the automatic establishment of the detail information 40 via the server 14 based on the user action-specific coordinates 36, it should be realized that the image 30 is the result of an interpretation of the data 20 and the underlying data points 34 at the server. A transformation rule underlying this interpretation thus defines a conversion of the data points 34 into image points of the image 30 and the location of the respective image point. The user action-specific coordinates 36 denote, for example, the image point within the image 30 to which the action of the user relates. Through an inverse of the transformation rule underlying the original interpretation of the data points 34 by the server for generation of the image 30, from such coordinates 36, the underlying data point 34 can be established. Once this has been established, everything that has not flowed, during the original generation of the image 30, into it can be transmitted as detail information 40 to the client 12 and is represented by the client 12 correctly positioned in relation to the image 30, i.e., at the location of the user action or in the vicinity of the location of the user action.

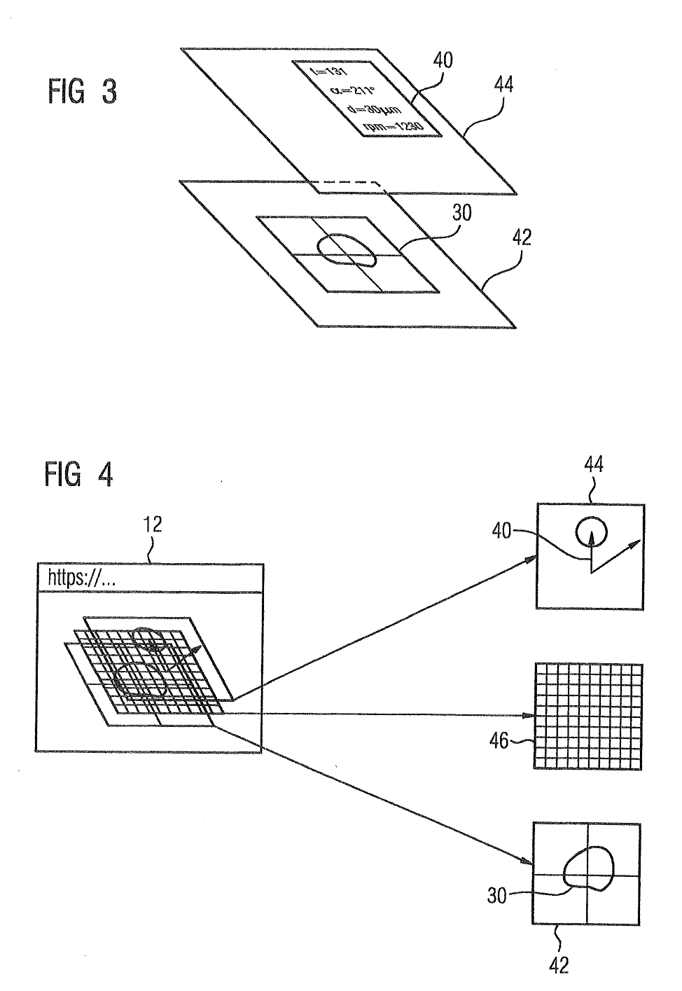

Preferably, the visualization of the detail information 40 together with the image previously transmitted to the client 12 occurs via different levels, as shown schematically simplified in the representation in FIG. 3. The use of two or more levels for overlaying different image content is in principle per se known. Such levels are separately addressable storage regions, the content of which can be selected for representation via the display unit. For differentiation, the levels used with the approach proposed here are designated the drawing level 42 and the information level 44.

The image 30 generated by the server 14 and transmitted to the client 12 is represented via the drawing level 42. This means that the data relating to the image 30 received from the server 14 by the client 12 is accepted into the storage region functioning as the drawing level 42.

In the case of receipt of a detail information item 40 from the server 14, the data relating thereto is loaded into the storage region functioning as an information level 44.

With a combination of the contents of both levels 42, 44, a representation of the detail information 40 is overlaid on the representation of the image 30 and at the client 12, the image 30 is displayed together with the respective detail information item 40 on its display unit. In this way, access to the data 20 is enabled and an interactive image is produced.

With regard to the detail information 40, it can be provided that the server 14 transmits the respective data to the client 12 and the client 12 itself provides for the representation of the data, i.e., for a generation of corresponding graphic data in the information level 44. Alternatively, the server 14 can generate an image (detail information image) based on the detail information 40 and transmit it to the client 12. The client 12 can display such a detail information image directly without further processing, in particular in that its data is loaded into the storage region functioning as the information level 44.

In the case of a creation of such a detail information image by the server 14, the image is preferably generated such that the resulting representation of the detail information 40 takes place in a spatial relation to the user action-specific coordinates 36, i.e., for example, the position of the graphic cursor 38. The server 14 has the user action-specific coordinates 36 already available as the basis for the establishment of the associated data point 34. On the basis thereof, the server 14 can generate a detail information image comprising a graphic of the detail information 40, where in this image, the graphic is positioned according to the respective user action-specific coordinates 36. Herein, account is specifically also taken of when the graphic cursor 38 is close to one of the lateral edges of the image 30 and the detail information 40 is positioned so that its complete representation is possible via the display unit of the client 12.

Whenever a new detail information item 40 is to be represented in response to a new user action (interaction), this is particularly efficiently possible on use of a separate level, specifically the information level 44. Either the content of the storage region functioning as the information level 44 is deleted and subsequently the graphic for a representation of the detail information 40 is generated and/or loaded positionally correctly into the storage region. Alternatively, the storage region functioning as the information level 44 is overwritten with the respective detail information 40, where the detail information 40 is generated so that a complete replacement of the previous content of the relevant storage region results.

For recognizing a user action and for establishing user action-specific coordinates 36, in one embodiment of the presently disclosed embodiments, a computer program designated an interaction layer 46 is provided. Such a computer program is useful if the display of the image 30 and/or the detail information 40 occurs via a standard program, for example, via a web browser. Such a standard program does not necessarily return the coordinates of a position of a graphic cursor 38, movable via a pointing device, in a form that is processable by other computer programs. The interaction layer 46 is provided for precisely this. For example, on a user action, for example, a “mouse click”, the interaction layer 46 returns the respective coordinates of the graphic cursor 38 that are then transmitted to the server 14 via the interaction layer 46.

The illustration in FIG. 4 shows the interaction layer 46 provided at the client 12 as a further level apart from the drawing level 42 and the information level 44. An imagined position of the interaction layer 46 relative to the drawing level 42 and the information level 44 is not of decisive importance herein. Shown here is a situation in which the interaction layer 46 is arranged above the drawing level 42, because a user action acquirable via the interaction layer 46 relates to the image 30 represented in the drawing level 42.

It should also be noted that the illustration in FIG. 4 (as distinct from the illustration in FIG. 2) shows a representation of a detail information item 40 in graphical form, whilst in the illustration in FIG. 2, a representation of the detail information item 40 in text form has been assumed. Both representation types are possible, where relevant also switchably, such that on a user action in the form of a click with the right mouse button, for example, a representation of a detail information item 40 in text form and, on a click with the left mouse button, a representation of the detail information 40 in graphical form is generated and displayed. Alternatively, a combination of both display types is also possible, for example, in the manner of a corresponding parameterization of the server 14 which, depending upon the parameterization, generates either a graphic of a textual display, a graphic of a graphic display or a graphic of a combination of a text and graphic display of the detail information 40 and transmits it to the client 12 for adoption there into the information level 44.

Finally, it should be noted that each formulation that describes or implies an action of the client 12 or the server 14, for example, a formulation such as “the server 14 generates the image 30 from the data 20” should be understood as meaning that the respective device 12, 14 performs the respective action based on and under the control of a computer program. In a per se known manner, for this the client 12 and the server 14 comprise a processing unit in the form of or in the manner of a microprocessor and a memory store in which a computer program executable via the processing unit and executed during operation is loaded. The computer program determines the functionality of the respective device 12, 14 and is thus a means for implementing the respective action and for implementing the or each of the method steps comprised by the respective action. This should always be borne in mind when considering the description set forth here.

Although the invention has been illustrated and described in detail with the preferred exemplary embodiment, the invention is not restricted by the examples given and other variations can be derived therefrom by a person skilled in the art without departing from the protective scope of the invention.

Individual significant aspects of the description set forth here can thus be briefly summarized as follows: What is disclosed is a method for transmitting data 30, 36, 40 to produce an interactive image, a computer program for implementing the method and a client-server system 10 functioning according to the method, where based on a scope of the data 20, the server 14 generates an image 30 based on the data 20 and transmits this to the client 12 for representation by the client 12 and where in the event of a user action in relation to the image 30, user action-specific coordinates 36 are transmitted from the client 12 to the server 14 that establishes in the data 20 a data point 34 associated with the user action-specific coordinates 36 and the detail information 40 thereof and transmits the detail information 40 to the client 12 for representation there.

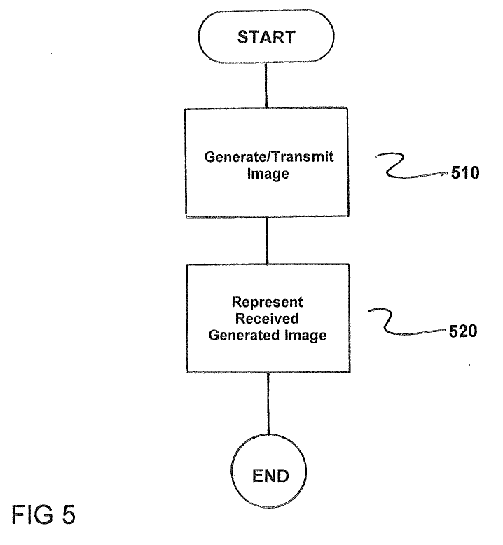

FIG. 5 is a flowchart of the method for transmitting data 30, 36, 40 to produce an interactive image via a client-server-system 10 in which a first device functions as a server 14 and a second device communicatively connected to the first device functions as a client 12. The method comprises generating, by the server 14, an image 30 based on the data 20 and transmitting said generated image 30 to the client 12, as indicated in step 510.

Next, the generated image 30 received from the server 14 is represented by the client 12 via a display unit, as indicated in step 520. In accordance with the method of the invention, herein in cases of a user action relating to the image 30, user action-specific coordinates 36 are transmitted to the server 14, where the server 14 establishes an associated data point 34 upon receipt of the coordinates 36 in the data 20 and transmits detail information 40 thereof to the client 12 which represents the detail information 40 at a location of the user action.

Thus, while there have been shown, described and pointed out fundamental novel features of the invention as applied to a preferred embodiment thereof, it will be understood that various omissions and substitutions and changes in the form and details of the devices illustrated, and in their operation, may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

1.-7. (canceled)

8. A method for transmitting data to produce an interactive image via a client-server-system in which a first device functions as a server and a second device communicatively connected to the first device functions as a client, the method comprising:
generating, by the server, an image based on the data and transmitting said generated image to the client; and
representing, by the client, the generated image received from the server via a display unit;
wherein in cases of a user action relating to the image, user action-specific coordinates are transmitted to the server, the server establishes an associated data point on receipt of the coordinates in the data and transmits detail information thereof to the client which represents the detail information at a location of the user action.

9. The method as claimed in claim 8, wherein the client represents the image received from the server in a drawing level and represents the detail information received from the server in an information level.

10. The method as claimed in claim 8, wherein the server, upon generating the image, utilizes a transformation rule for converting the data into image points of the image; and
wherein the server applies an inverse of the transformation rule on the user action-specific coordinates to establish the associated data point.

11. The method as claimed in claim 9, wherein the server, upon generating the image, utilizes a transformation rule for converting the data into image points of the image; and
wherein the server applies an inverse of the transformation rule on the user action-specific coordinates to establish the associated data point.

12. The method as claimed in claim 8, wherein the client administers an interaction layer for establishing the user-specific coordinates; and
wherein, via the interaction layer, coordinates of a graphic cursor movable relative to the image represented by the client by a pointing device of the client are established and transmitted to the client as user action-specific coordinates.

13. The method as claimed in claim 9, wherein the client administers an interaction layer for establishing the user-specific coordinates; and
wherein, via the interaction layer, coordinates of a graphic cursor movable relative to the image represented by the client by a pointing device of the client are established and transmitted to the client as user action-specific coordinates.

14. The method as claimed in claim 10, wherein the client administers an interaction layer for establishing the user-specific coordinates; and
wherein, via the interaction layer, coordinates of a graphic cursor movable relative to the image represented by the client by a pointing device of the client are established and transmitted to the client as user action-specific coordinates.

15. A non-transitory computer readable medium encoded with a computer program and configured to transmit data to produce an interactive image via a client-server-system in which a first device functions as a server and a second device communicatively connected to the first device functions as a client, the computer program comprising:
program code for generating, by the server, an image based on the data and for transmitting the image to the client;
program code for receiving, by the server, user action-specific coordinates from the client and for establishing an associated data point and detail information thereof in the data; and
program code for transmitting, by the server, the detail information to the client.

16. A non-transitory computer-readable medium encoded with a computer program and configured to transmission of data to produce an interactive image via a client-server-system in which a first device functions as a server and a second device communicatively connected to the first device functions as a client, the computer program comprising:
program code for representing, by the client, the image received from the server via a display unit;
program code for acquiring, by the client, user action-specific coordinates in cases of a user action related to the image and for transmitting the coordinates to the server; and
program code for receiving a detail information item from the server and for representing the detail information item at a location of the user action.

17. A client-server system comprising:
a device functioning as a server; and
at least one further device functioning as a client;
wherein the server and each client includes a respective processing unit and a respective memory store into which the computer program which is executable by the respective processing unit is loadable; and
wherein the computer program encoded in the non-transitory computer-readable medium of claim 16 is loaded into the memory store of the client

18. A client-server system comprising:
a device functioning as a server; and
at least one further device functioning as a client;
wherein the server and each client includes a respective processing unit and a respective memory store into which the computer program which is executable by the respective processing unit is loadable; and
wherein the computer program encoded in the non-transitory computer-readable medium of claim 15 is loaded into the memory store of the server.
